(19) United States
(12) Patent Application Publication
(10) Pub. No.: US 2022/0120125 A1
(43) Pub. Date: Apr. 21, 2022

(54) ASSEMBLY OF A STRIP FOR CONNECTING A LEAF TO A FRAME IN AN ARTICULATED MANNER ABOUT A HINGE AXIS, AND STRIP COMPRISING SAID ASSEMBLY

(71) Applicant: DR. HAHN GMBH & CO. KG, MOENCHENGLADBACH (DE)

(72) Inventors: MARKUS LENZE, NETTETAL (DE); MICHAEL HAHN, MOENCHENGLADBACH (DE)

(73) Assignee: DR. HAHN GMBH & CO. KG, MOENCHENGLADBACH (DE)

(21) Appl. No.: 17/289,240

(22) PCT Filed: Sep. 24, 2019
(86) PCT No.: PCT/EP2019/075681

§ 371 Date: Apr. 28, 2021

(30) Foreign Application Priority Data
Oct. 31, 2018 (DE) 10 2018 127 282.0

(51) Int. Cl. E05D 7/04; E05D 7/12

(52) U.S. Cl. CPC E05D 7/0423; E05D 3/02; E05D 7/12

(57) ABSTRACT

The invention relates to an assembly (100) of a strip for connecting a leaf to a frame in an articulated manner about a hinge axis (S), comprising an installation part (10) which can be installed on an installation side of the leaf or the frame, a strip tab (20) which can be secured to the installation part (10), and a first adjustment means (50), by means of which the strip tab (20) can be pivoted relative to the installation part (10) in an adjustment range (J) about a pivot axis (B) extending parallel to the hinge axis (S), wherein, of the installation part (10) and the strip tab (20), one has a securing groove (31) with a groove opening (32) and a groove longitudinal axis (A), which extends parallel to the hinge axis (S), and the other of the installation part (10) and the strip tab (20) has a securing protrusion (35) which engages into the securing groove (31). The securing groove (31) and the securing protrusion (35) are designed such that the securing protrusion (35) can be inserted into the securing groove (31) perpendicularly to the groove longitudinal axis (A) by pivoting the strip tab (20) relative to the installation part (10) substantially about the pivot axis (B).

### CROSS REFERENCE TO PRIOR APPLICATIONS

This application is a U.S. National Phase application under 35 U.S.C. § 371 of International Application No. PCT/EP2019/075681, filed on Sep. 24, 2019 and which claims benefit to German Patent Application No. 10 2018 127 282.0, filed on Oct. 31, 2018. The International Application was published in German on May 7, 2020 as WO 2020/088850 A1 under PCT Article 21(2).

### FIELD

The present invention relates to an assembly of a strip for connecting a leaf to a frame in an articulated manner about a hinge axis, comprising an installation part which can be installed on an installation side of the leaf or the frame, a strip tab which can be secured to the installation part, and a first adjustment device via which the strip tab can be pivoted relative to the installation part in an adjustment range about a pivot axis extending parallel to the hinge axis, in particular by an adjustment angle, wherein, of the installation part and the strip tab, one has a securing groove with a groove opening and a groove longitudinal axis, which extends parallel to the hinge axis, and the other of the installation part and the strip tab has a securing protrusion which engages into the securing groove. The present invention also relates to a strip comprising such an assembly.

### BACKGROUND

A strip comprising such an assembly is described in EP 2 725 174 A1. Since the strip tab can be pivoted about the pivot axis with respect to the installation part, an adjustment of the leaf in the frame in a direction perpendicular to the hinge axis (which is also referred to as the horizontal adjustment) is possible in a simple manner by turning the pressure screw. The adjustment in the vertical direction takes place via a support screw supporting the strip tab and a counter-acting counter screw. It has, however been shown in practice that the assembly of the strip tab on the installation part and the vertical adjustment are made more difficult, in particular when space is limited.

### SUMMARY

An aspect of the present invention is therefore to provide an assembly of the type mentioned above and a strip comprising this assembly which improve on at least one of the disadvantages mentioned above and which in particular allow for an uncomplicated installation and disassembly of the assembly or the strip.

In an embodiment, the present invention provides an assembly of a strip for connecting a leaf to a frame in an articulated manner about a hinge axis. The assembly includes an installation part which is configured to be installed on an installation side of the leaf or of the frame, a strip tab which is configured to be secured to the installation part, and a first adjustment device which is configured to pivot the strip tab relative to the installation part in an adjustment range about a pivot axis which extends parallel to the hinge axis. One of the installation part and the strip tab comprises a securing groove which comprises a groove opening and a groove longitudinal axis, the groove longitudinal axis extending parallel to the hinge axis, and the other one of the installation part and the strip tab comprises a securing protrusion which is configured to engage into the securing groove. The securing groove and the securing protrusion are configured so that the securing protrusion is insertable into the securing groove perpendicular to the groove longitudinal axis. Advantageous embodiments and developments of the present invention are described in the claims, the description, and the drawings.

### BRIEF DESCRIPTION OF THE DRAWINGS

The present invention is described in greater detail below on the basis of embodiments and of the drawings in which:

FIG. 1 is a perspective view of a first embodiment of a strip according to the present invention in an exploded view;

FIG. 2 shows the strip in an installed state in a perspective view;

FIG. 3 shows the strip in an installed state in a side view in the direction of the hinge axis;

FIG. 4 is a perspective view of a second embodiment of a strip according to the present invention in an exploded view;

FIG. 5 shows the strip in an installed state in a front view perpendicular to the hinge axis;

FIG. 6 shows the strip in an installed state in a side view in the direction of the hinge axis; and

FIG. 7 shows the strip in an installed state in a sectional view in the direction of the hinge axis.

### DETAILED DESCRIPTION

According to the present invention, the securing groove and the securing protrusion are designed so that the securing protrusion can be inserted into the securing groove perpendicular to the groove longitudinal axis, in particular by pivoting the strip tab relative to the installation part substantially about the pivot axis. The strip tab can thereby be installed directly on the front side of the installation part, i.e., on the flat side of the installation part facing away from the leaf or the frame, for example, after securing the installation part to a leaf or a frame. The strip tab can in particular be installed without the need to slide the strip tab laterally on a narrow side of the installation part and without a corresponding space requirement on this narrow side, in particular above and below the installation part installed on a leaf or a frame. The design of the respective securing regions, in particular the securing protrusion and the securing groove, in particular with a groove opening which allows the securing protrusion to be received perpendicular to the groove longitudinal axis, as well as the resulting possibility of sliding or inserting the two securing regions into one another in a direction parallel to the hinge axis, allows for a particularly uncomplicated and quick installation of the assembly.

The phrase “one of the installation part and the strip tab” always means that the measure to which this formulation relates can be provided either on the installation part or on the strip tab. The phrase “the other of the installation part and the strip tab” is accordingly intended to express that the situation to which the last formulation relates is then located on the other component, i.e., either on the strip tab or on the installation part. The “groove longitudinal axis” is furthermore only to be understood as the direction of the longitudinal extent of the groove; it is not intended to imply that the groove must have a round design. The groove is rather, for example, designed as an angular depression. The pivot axis of the strip tab with respect to the installation part is furthermore not to be understood as a necessarily fixed pivot axis; rather, when the strip tab is pivoted relative to the installation part, the strip tab can move in a trajectory, with the actual pivot axis being able to be shifted slightly in parallel.

In an embodiment of the present invention, one of the installation part and the strip tab can, for example, comprise a guide recess which is arranged at a distance from the securing groove in the direction perpendicular to the longitudinal axis and which has a recess length parallel to the groove longitudinal axis and a recess depth substantially perpendicular to the groove longitudinal axis, which is delimited by two side walls, and the other of the installation part and the strip tab can, for example, comprise a guide protrusion which engages in the guide recess and which is in engagement with the guide recess in the adjustment range and which has a protrusion length and a protrusion height which are delimited by two side surfaces. Additional holding forces can thereby be introduced from the strip tab into the installation part without making the adjustability difficult or impaired. The guide recess and the guide protrusion can, for example, be designed so that the strip tab can be inserted both with the securing protrusion perpendicular into the securing groove and with the guide protrusion perpendicular into the guide recess, in particular when pivoting relative to the installation part substantially about the pivot axis, for example, during the installation and disassembly of the strip tab with respect to the installation part.

The guide recess can, for example, be designed so that the recess length thereof extends over the total extent of one of the installation part and of the strip tab. The guide protrusion can, for example, accordingly be designed so that the protrusion length thereof extends over the total extent of the other of the installation part and the strip tab. These measures serve to try to enlarge the surfaces on which the guide protrusion and the guide recess lie against one another as much as possible in order to reduce the surface loads in view of the highest possible load capacity of the assembly according to the present invention.

In order to further intensify the aforementioned effect, it can be provided that, in the direction of the recess depth, the side walls of the guide recess each have a slope that is directed to the pivot axis, or a curvature having a radius of curvature which corresponds approximately to the distance of the respective side wall from the pivot axis. Due to the slope or inclination of the side walls, during the abutment of the guide protrusion, further forces or force components can be introduced into the installation part by the strip tab, in particular an improved alignment.

If the side surfaces of the guide protrusion each have, for example, a slope in the direction of the protrusion height, which is directed to the pivot axis (B), or a curvature, which corresponds approximately to the distance of the respective side surface from the pivot axis, it can be achieved that a jam-free adjustment is provided even when the assembly according to the present invention is under a high load.

If the recess depth and the protrusion height are, for example, dimensioned so that the guide protrusion is in engagement with the guide recess over the entire adjustment range, these measures provide that the assembly according to the present invention can be displaced without jamming while the assembly according to the present invention can withstand high loads over the entire adjustment range.

In an embodiment of the present invention, the first adjustment device can, for example, comprise at least one tension screw, which is screwed around a tension screw thread of the installation part and which passes through the strip tab in an opening which can, for example, be elongated in the direction parallel to the pivot axis and which abuts with a head against the edge of the opening, and a pressure screw, which is screwed into a pressure screw thread of the strip tab and which comprises an end face leading in the screwing direction and which is supported on an abutment surface of the installation part. In practice, depending on whether the assembly belongs to an upper or a lower strip of a leaf/frame arrangement, forces act on the strip tabs which are either directed toward the abutment surface or away from it. For adjustment purposes, in the first case, the tension screw is first slightly loosened that was previously tightened to counter the pressure screw. The desired horizontal adjustment can then be made by turning the pressure screw. A turning operation in the sense of screwing the pressure screw into the threaded bore thus leads to a pivoting of the strip tab about the pivot axis in the sense of an increase in the adjustment angle. The tension screw is then tightened again after reaching the desired adjustment position. In the event that forces act on the strip tabs which are directed away from the contact surface, the pressure screw is in practice initially turned in the sense of loosening until a distance is reached between its end face and the contact surface that allows for a pivoting by turning the tension screw until the desired adjustment position is reached. Since the head of the tension screw is supported on the strip tab, actuation of the tension screw in the sense of screwing it in leads to a pivoting of the strip tab in the sense of reducing the adjustment angle. The pressure screw is then displaced again against the contact surface by a corresponding turning operation. By countering the pressure screw and the tension screw, the strip tab can be blocked against pivoting with respect to the installation part and a leaf can thus be fixed in relation to a frame in a horizontal adjustment position that has been reached. The abutment surface, also called the contact surface, can in particular be offset from an adjacent surface, material-reinforced, and/or coated.

The edge of the opening can, for example, be formed by a countersink or by milling with a base, with the head of the tension screw abutting against the base. The head of the tension screw thereby protrudes less, for example, not beyond the outer contour of the strip tab, whereby the space required for the use of the assembly according to the present invention can be reduced and its visual appearance can be improved.

The pressure screw can, for example, be designed as a stud screw. This has the advantage that it can be screwed into the pressure screw thread from both sides of the strip tab before the strip tab and the installation part are joined. The additional space required for a head is also eliminated. The end face of the pressure screw can, for example, have a flat design. This provides a constant, linear contact between the end face and the contact surface, regardless of the respective turning position of the pressure screw.

In a development of the present invention, a second adjustment device can, for example, be provided with which the strip tab can be displaced in the direction of the groove longitudinal axis relative to the installation part. An adjustment in the direction of the hinge axis (which is also called vertical adjustment) is thereby possible with the assembly according to the present invention.

The second adjustment device can have a support screw for this purpose which is screwed into a first threaded bore of the installation part extending parallel to the hinge axis and on which the strip tab is supported with a first side region arranged between the securing protrusion or the securing groove and the hinge axis. A vertical adjustment is made possible by turning the support screw. In order to be able to fix the strip tab in relation to the installation part in an achieved vertical adjustment position, a counter screw can, for example, be provided which is screwed into a second threaded bore of the installation part extending parallel to the hinge axis and so as to abut against a second side region of the strip tab opposite the first side regions and to press against the support screw. The counter screw is in practice tightened when the desired vertical adjustment position has been achieved with the help of the support screw. A particularly tight fit of the strip tab with respect to the installation part can thereby be achieved. The side region is in particular to be understood as the outer narrow side of the installation part, but it can also include a surface specially arranged for support.

The support screw and the counter screw can, for example, each be designed as a screw pin having an external thread, which screw pin has a wrench surface, such as a hexagon socket or a hexalobular socket, at a first axial end and which has a plate-shaped head protruding radially outward at the opposite second axial end. As a result, the support screw and the counter screw allow, namely, with the wrench surface region accessible from the environment, for a reduction of the space required for the use of the assembly according to the present invention and an improvement of its visual appearance, and, namely, with the plate-shaped head, an improved introduction of force onto the strip tab, in particular in the entire adjustment range of the strip tab.

The present invention also encompasses a strip for connecting a leaf to a frame in an articulated manner around a hinge axis, comprising an assembly according to the present invention.

Two embodiments of a strip according to the present invention (hereinafter “strip” for short) and an assembly according to the present invention (hereinafter “assembly” for short) are explained in greater detail below under reference to the drawings. Like reference signs thereby denote like components.

The assembly of a strip, denoted as a whole by 100 in the drawings, serves for connecting a leaf to a frame in an articulated manner about a hinge axis S. The assembly 100 comprises an installation part 10 and a strip tab 20.

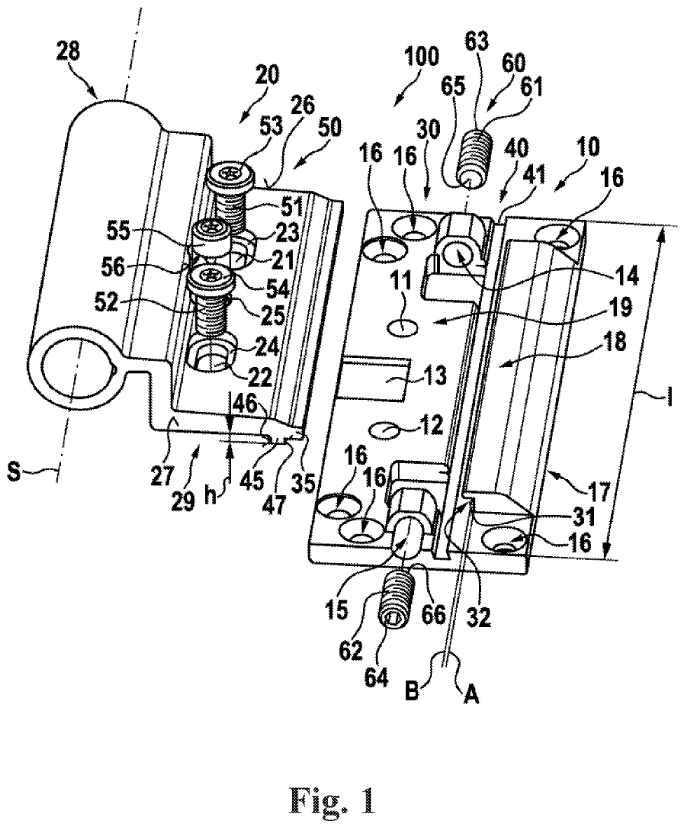

The installation part 10 is substantially designed as a flat part and can be installed with a flat side 17 at the rear in FIG. 1 on an installation side of a leaf or frame (which is not shown in the drawings). The securing process takes place in particular via securing screws (which are also not shown in the drawings) which extend through bores 16 of the installation part 10 and which are screwed into the leaf or the frame so that the installation part 10 is fixed to the leaf or to the frame.

A securing device 30 for securing and adjusting the strip tab 20 is provided in the region of a flat side 18 of the installation part 10 facing the viewer of FIG. 1. The securing device 30 includes, among other things, a securing groove 31 for fixing the strip tab 20 at least on one side on the installation part 10. In the present case, the securing groove 31 is formed, for example, by a flange protruding from the flat side 18 and has a groove longitudinal axis A extending parallel to the hinge axis S and a groove opening 32 facing substantially perpendicular to the groove longitudinal axis A in the direction of a receiving region 19 for receiving the strip tab 20. The securing groove 31 in particular serves to receive a corresponding securing protrusion 35 of the installation part 10.

The strip tab 20 comprises a hinge part 28, which comprises a receptacle for a strip bolt (which is not shown in the drawings) that defines the hinge axis S, and a securing part 29 arranged substantially parallel to the hinge axis S.

The securing protrusion 35 provided for engaging with the securing groove 31 is arranged in the region of the securing part 29, which in the present case is in a side edge region of the strip tab 20 facing away from the hinge part 28. The securing protrusion 35 protrudes in this case by way of example on the side of the strip tab 20 facing away from the hinge part 28 or is formed by the side edge, in particular with a protrusion length v extending over the entire length of the hinge part 28 and a predefined projecting protrusion height h. The securing protrusion 35 is in particular adapted to the securing groove 31 so that the securing protrusion 35 can be pushed into the securing groove 31 in the direction perpendicular to the groove longitudinal axis A and can be supported therein with play so that the strip tab 20 pushed into the securing groove 31 by an adjustment angle a in an adjustment range J can be pivoted about a pivot axis B with respect to the installation part 10.

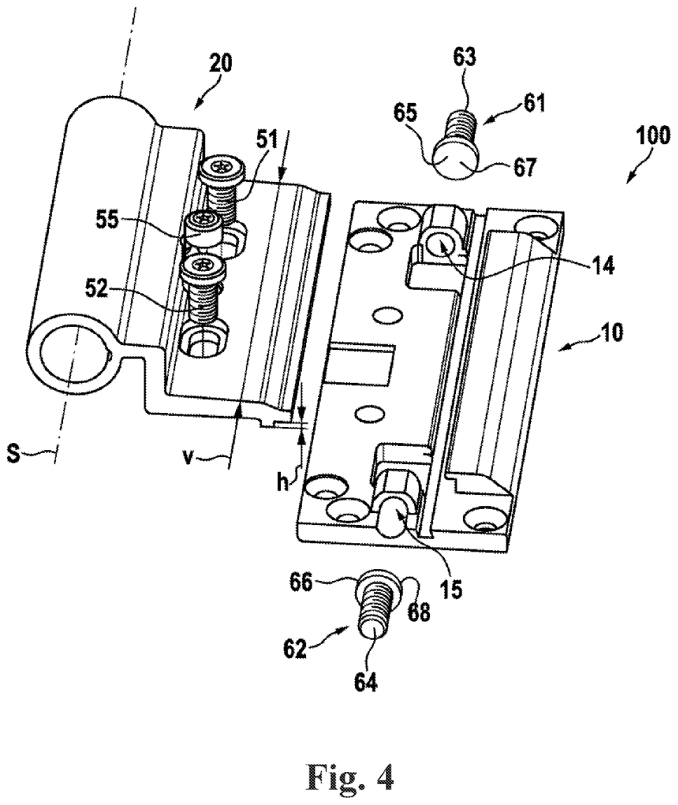

To secure and adjust the strip tab 20 with respect to the installation part 10, the securing device 30 further comprises first adjustment device 50 with which the strip tab 20 can be pivoted about the pivot axis B and can be fixed in a desired adjustment position on the installation part 10. The first adjustment device 50 in the present case comprises a pressure screw 55, which in the illustrated embodiment is designed as a stud screw and is mounted in a pressure screw thread 25 of the strip tab 20. The pressure screw 55 has an end face 56 which leads in the screwing-in direction and which is supported on an abutment or contact surface 13 of the installation part 10. As can in particular be seen in FIGS. 1 and 4, the abutment or contact surface 13 is offset from an adjacent side surface.

In addition to the pressure screw 55, the securing device 30 or the first adjustment device 50 also has two tension screws 51, 52 which are arranged in the assembly 100 in the direction parallel to the pivot axis B on both sides of the pressure screw 55. The tension screws 51, 52 are screwed into a respective tension screw thread 11, 12 of the installation part 10, and each pass through the strip tab 20 in an opening that is elongated in the direction parallel to the pivot axis B, in this case openings 21 and 22. Each opening 21, 22 has an edge which is formed by a base 23, 24, which is in particular produced by a countersink or milling, and on which the respective tension screw 51, 52 is supported. The head 53, 54 of the respective tension screw 51, 52 in particular abuts against the base 23, 24 with an edge facing the screw thread.

By screwing and pre-tensioning the tension screws 51, 52 and the pressure screw 55, which act against one another, the strip tab 20 can be tensioned or fastened in an adjusted position on the installation part 10.

A guide device 40 is provided in the present case for an additional introduction of force from the strip tab 20 into the installation part 10 and/or an additional guidance of the strip tab 20 with respect to the installation part 10. The guide device 40 comprises a guide recess 41 which is arranged on the installation part 10 in the receiving region 19 and a guide protrusion 45 which is designed in a complementary manner on the strip tab 20. In the installed state, the guide protrusion 45 of the strip tab 20 engages into the guide recess 41 of the installation part 10, in particular over the entire adjustment range J.

In the present case, the guide recess 41 is in particular arranged parallel to the groove longitudinal axis A, adjacent to the groove opening 32, has a recess depth t and two side walls 42, 43, and extends with a recess length I over the entire length of the installation part 10. In the present case, the side walls 42, 43 each have a slope or an inclination directed toward the pivot axis B in the direction of the recess depth t. The side walls 42, 43 and thus the guide recess 41 are consequently not designed perpendicular with respect to the flat side 18, but rather at an angle, in particular inclined.

The guide protrusion 45 is arranged parallel to and adjacent to the securing protrusion 35, has a protrusion height h, and two side surfaces 46, 47, and extends with a protrusion length v over the entire length of the strip tab 20. In the present case, the side surfaces 46, 47 also have a slope or an inclination directed toward the pivot axis B in the direction of the protrusion height h. The guide protrusion 45 is thus designed to correspond to the guide recess 41, there being a slight play between the guide protrusion 45 and the guide recess 41 in the installed state. Depending on the force acting on the strip tab 20, the side surface 46 can in particular abut against the side wall 42 or the side surface 46 can abut against the side wall 43.

For the purpose of vertical adjustment of the strip tab 20 with respect to the installation part 10, i.e., in the direction of the groove longitudinal axis A, an additional second adjustment device 60 is provided with which the strip tab 20 can be displaced in the direction of the groove longitudinal axis A relative to the installation part 10. The second adjustment device 60 comprises a support screw 61 and a counter screw 62.

The support screw 61 is screwed into a first threaded bore 14 of the installation part 10 that extends parallel to the hinge axis S and presses with a leading end face 65 against a side region of the strip tab 20, in this case a first side region 26 arranged between the securing protrusion 35 and the hinge axis S. In a second axial end 63 of the support screw 61 opposite the leading end face 65, a wrench surface, such as a hexagon socket or a hexalobular socket, is provided for receiving a corresponding tool. The counter screw 62 is screwed into a second threaded bore 15 of the installation part 10, which also extends parallel to the hinge axis S, and presses with a leading end face 66 against a second side region 27 of the strip tab 20 opposite the first side region 26. A wrench surface for receiving a corresponding tool is again provided in a second axial end 64 of the support screw 61 opposite the leading end face 66. The strip tab 20 can be displaced and fixed relative to the installation part 10 in the direction of the groove longitudinal axis A by alternately screwing in and unscrewing the screws 61, 62, for example, by loosening the support screw 61 and tightening the counter screw 62 until the strip tab 20 is again tensioned against the support screw 61. It should be clear that, depending on the alignment of the assembly 100 on a leaf and a frame, the support screw 61 can of course also assume the mode of action of the counter screw 62, and the counter screw 62 can assume the mode of action of the support screw 61.

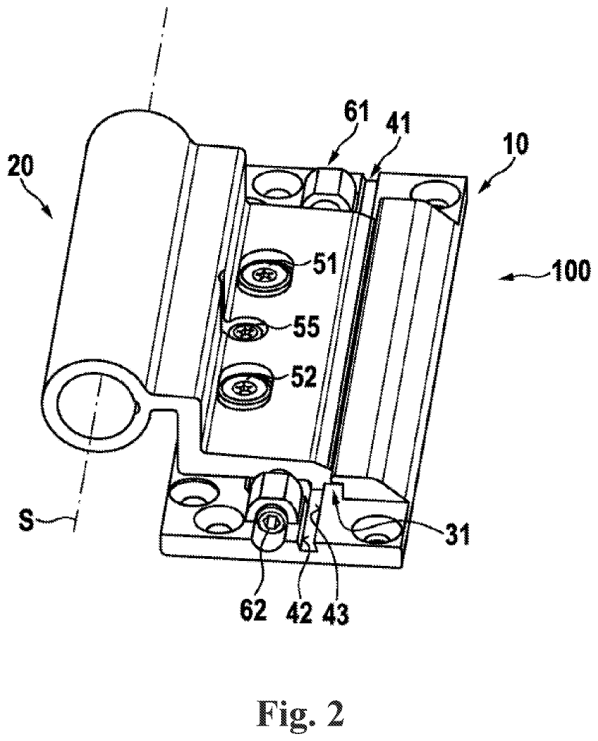

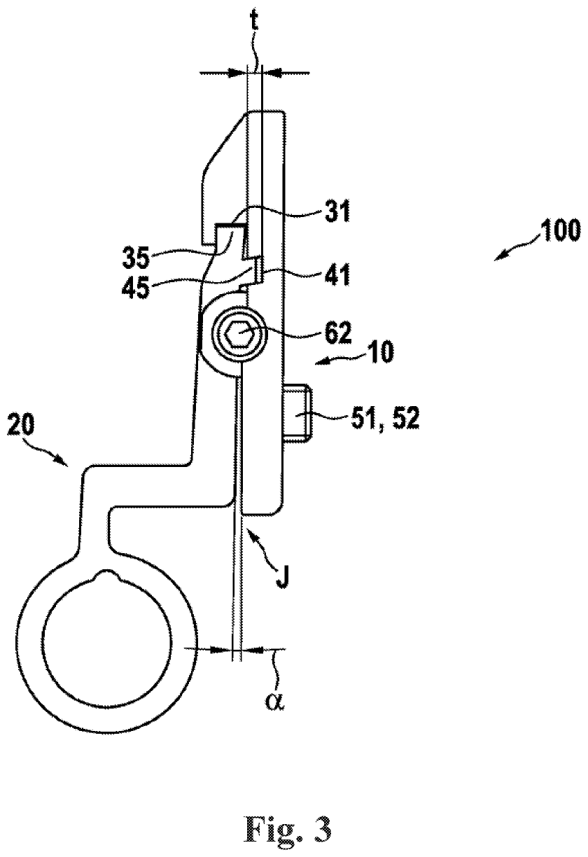

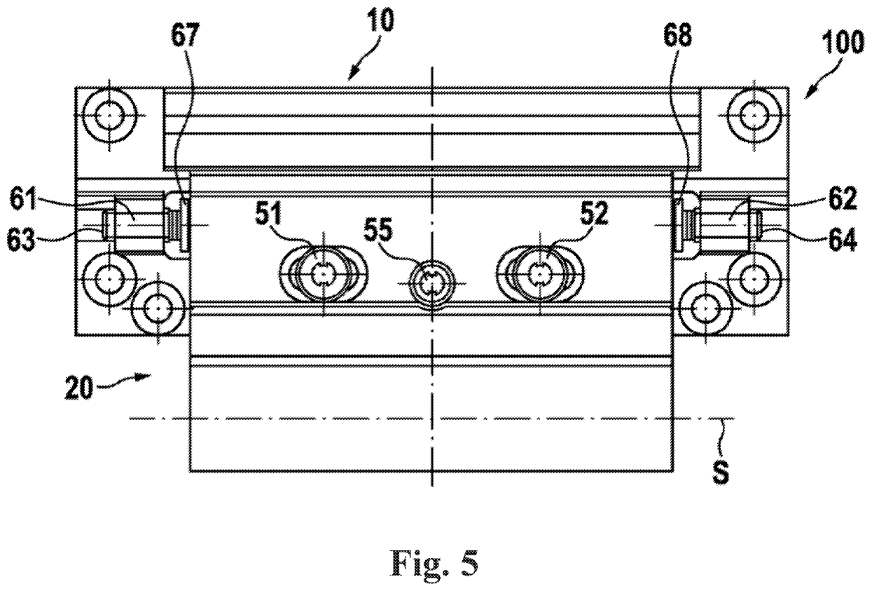

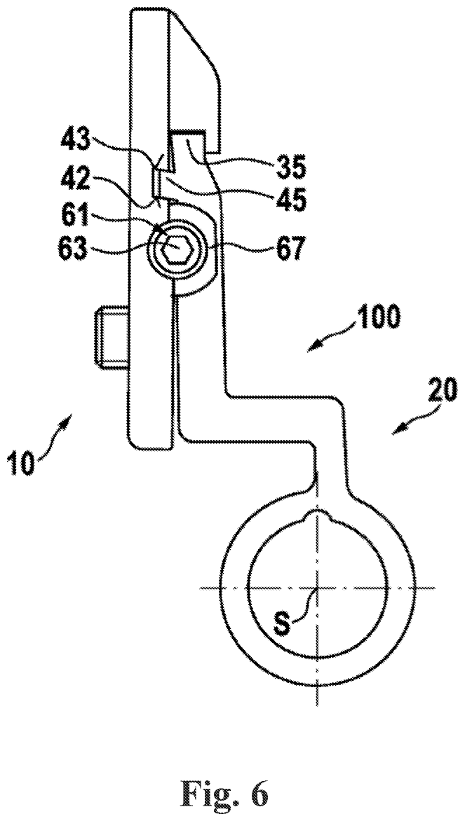

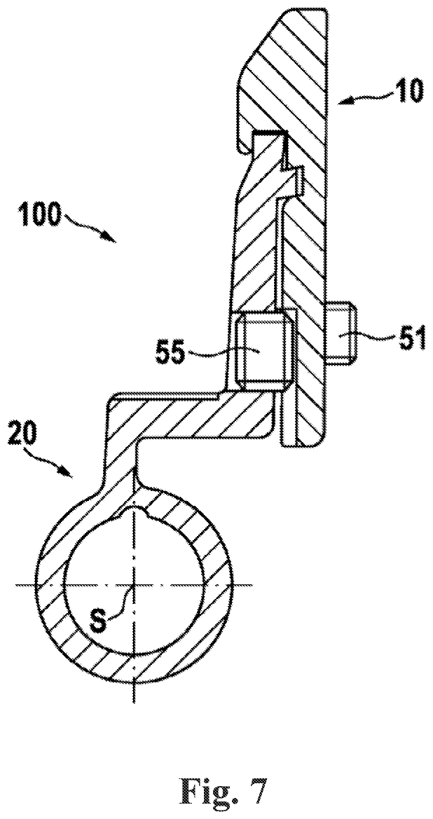

The first embodiment of the assembly 100 shown in FIGS. 1 to 3 differs from the second embodiment shown in FIGS. 4 to 7 only in the design of the screws 61, 62.

In the first embodiment shown in FIGS. 1 to 3, the support screw 61 and the counter screw 62 are each designed as a stud screw. This allows the screws 61, 62 to be subsequently screwed into the threaded bore 14, 15 from the outside, i.e., in particular at the time of final installation.

In the second embodiment shown in FIGS. 4 to 7, the support screw 61 and the counter screw 62 are each designed as a head screw, a respective head 67, 68 being arranged on an axial end 65, 66 of the screw facing the strip tab 20. The head 67, 68 is in particular designed as a plate-shaped part protruding radially outward from the screw pin. On the end face of the head 67, 68 facing the strip tab 20, which serves as a contact surface on the strip tab 20, the head 67, 68 can, for example, be designed over the entire surface and flat. The contact surface of the screw 61, 62 on the strip tab 20 is in particular enlarged as a result so that the screw 61, 62 is provided with a sufficiently large contact region for the force transmission even when there a relatively large adjustment angle a exists, i.e., when the strip tab 20 is at a relatively large distance from the installation part 10 on the strip tab 20.

It should be clear that the scope of protection of the present invention is not limited to the embodiments described. The structure and the arrangement of the securing device and/or the guide device can in particular be modified without changing the essence of the present invention. The securing groove, the securing protrusion, the guide recess, and/or the guide protrusion in the respective longitudinal extension, i.e., in the direction parallel to the hinge axis S, can, for example, also be designed only in portions over a total length of the respective component. Reference should also be had to the appended claims.

### LIST OF REFERENCE NUMERALS

10 Installation part

11 Tension screw thread

12 Tension screw thread

13 Abutment or contact surface

14 First threaded bore

15 Second threaded bore

16 Bore

17 Flat side

18 Flat side

19 Receiving region

20 Strip tab

21 Opening

22 Opening

23 Base

24 Base

25 Pressure screw thread

26 First side region

27 Second side region

28 Hinge part

29 Securing part

30 Securing device

31 Securing groove

32 Groove opening

35 Securing protrusion

40 Guide device

41 Guide recess

42 Side wall

43 Side wall

45 Guide protrusion

46 Side surface

47 Side surface

50 First adjustment device

51 Tension screw

52 Tension screw

53 Head

54 Head

55 Pressure screw

56 End face

60 Second adjustment device

61 Support screw

62 Counter screw

63 Second axial end

64 Second axial end

65 Leading end face/Axial end

66 Leading end face/Axial end

67 Head

68 Head

100 Assembly

A Groove longitudinal axis

B Pivot axis

S Hinge axis

α Adjustment angle

J Adjustment range

t Recess depth

v Protrusion length

h Protrusion height

I Recess length

What is claimed is:

1. Assembly (100) of a strip for connecting a leaf to a frame in an articulated manner about a hinge axis (S),
comprising an installation part (10) which can be installed on an installation side of the leaf or the frame,
a strip tab (20) which can be secured to the installation part (10), and a first adjustment means (50), by means of which the strip tab (20) can be pivoted relative to the installation part (10) in an adjustment range (J) about a pivot axis (B) extending parallel to the hinge axis (S), wherein, of the installation part (10) and the strip tab (20), one has a securing groove (31) with a groove opening (32) and a groove longitudinal axis (A), which extends parallel to the hinge axis (S),
and the other of the installation part (10) and the strip tab (20) has a securing protrusion (35) which engages into the securing groove (31), characterized in that
the securing groove (31) and the securing protrusion (35) are designed such that the securing protrusion (35) can be inserted into the securing groove (31) perpendicularly to the groove longitudinal axis (A).

2. Assembly according to claim 1, characterized in that one of the installation part (10) and the strip tab (20) comprises a guide recess (41) which is arranged at a distance from the securing groove (31) in the direction perpendicular to the longitudinal axis (A) and has a recess length (I) parallel to the groove longitudinal axis (A) and a recess depth (t) substantially perpendicular to the groove longitudinal axis (A), which is delimited by two side walls (42, 43), and the other of the installation part (10) and the strip tab (20) comprises a guide protrusion (45) which engages in the guide recess (41) and which is in engagement with the guide recess (41) in the adjustment range (J) and has a protrusion length (v) and a protrusion height (h) which are delimited by two side surfaces (46, 47), and the guide protrusion (45) can be inserted perpendicularly into the guide recess (41).

3. Assembly according to claim 2, characterized in that the recess length (I) extends over the total extent of one of the installation part (10) and the strip tab (20) and the protrusion length (v) extends over the total length of the other of the installation part (10) and of the strip tab (20).

4. Assembly according to either claim 2 or claim 3, characterized in that, in the direction of the recess depth (t), the side walls (42, 43) of the guide recess (41) each have a slope that is directed to the pivot axis (B), or a curvature having a radius of curvature which corresponds approximately to the distance of the respective side wall (42, 43) from the pivot axis (B).

5. Assembly according to any of claims 2 to 4, characterized in that the side surfaces (46, 47) of the guide protrusion (45) each have a slope in the direction of the protrusion height (h), which is directed to the pivot axis (B), or a curvature which corresponds approximately to the distance of the respective side surface (46, 47) from the pivot axis (B).

6. Assembly according to any of claims 2 to 5, characterized in that the recess depth (t) and the protrusion height (h) are dimensioned such that the guide protrusion (45) is in engagement with the guide recess (41) over the entire adjustment range (J).

7. Assembly according to any of the preceding claims, characterized in that the first adjustment means (50) has at least one tension screw (51, 52) which is screwed around a tension screw thread (11, 12) of the installation part (10) and passes through the strip tab (20) preferably in an elongated opening (21, 22) in the direction parallel to the pivot axis (S) and abuts with a head (53, 54) against the edge of the opening (21, 22), and a pressure screw (55), which is screwed into a pressure screw thread (25) of the strip tab (20) and comprises an end face (56) leading in the screwing-in direction and which is supported on an abutment surface (13) of the installation part (10).

8. Assembly according to claim 7, characterized in that the edge of the opening (21, 22) is formed by a countersink or milling with a base (23, 24), and the head (53, 54) of the tension screw (51, 52) abuts against the base (23, 24).

9. Assembly according to either claim 7 or claim 8, characterized in that the pressure screw (55) is designed as a stud screw, and the end face (56) of the pressure screw (55) is flat.

10. Assembly according to any of the preceding claims, characterized in that a second adjustment means (60) is provided, with which the strip tab (20) can be displaced in the direction of the groove longitudinal axis (A) relative to the installation part (10).

11. Assembly according to claim 10, characterized in that the second adjustment means (60) comprises a support screw (61) which is screwed into a first threaded bore (14) of the installation part (10) extending parallel to the hinge axis (S) and on which the strip tab (20) is supported with a first side region (26) arranged between the securing protrusion (35) or the securing groove (31) and the hinge axis (S), and a counter screw (62) which is screwed into a second threaded bore (15) of the installation part (10) extending parallel to the hinge axis (S) and abuts against a second side region (27) of the strip tab (20) opposite the first side regions (26) and presses against the support screw (61).

12. Assembly according to claim 11, characterized in that the support screw (61) and the counter screw (62) are each designed as a screw pin having an external thread, which screw pin has a wrench surface at a first axial end (63, 64) and has a plate-shaped head (67, 68) protruding radially outward at the opposite second axial end (65, 66).

13. Strip for connecting a leaf to a frame in an articulated manner about a hinge axis (S), comprising an assembly (100) according to any of the preceding claims.
